(19) United States
(12) Patent Application Publication
(10) Pub. No.: US 2025/0320412 A1
(43) Pub. Date: Oct. 16, 2025

(54) APPARATUSES AND METHODS FOR IMPROVED DISTILLATION OF SUSTAINABLE AVIATION FUEL

(71) Applicant: Gevo, Inc., Englewood, CO (US)

(72) Inventor: William Randall Vetter, Englewood, CO (US)

(21) Appl. No.: 19/175,704

(22) Filed: Apr. 10, 2025

Related U.S. Application Data
(60) Provisional application No. 63/633,140, filed on Apr. 12, 2024.

(51) Int. Cl. C10G 7/06; B01D 3/20

(52) U.S. Cl. CPC C10G 7/06; B01D 3/20; C10G 2400/08

(57) ABSTRACT

A distillation system for the production of sustainable aviation fuel is provided. The system has a distillation tower. A liquid trap in the tower has a through channel to allow vapor to flow from below the liquid trap to above the liquid trap, and the liquid trap, which may comprise a tray, traps and retains the fuel. A pump pumps the fuel from the liquid trap through a cooler to the top of the distillation tower.

### CROSS-REFERENCE TO RELATED PATENT APPLICATIONS

This application claims the benefit of co-pending U.S. Provisional Patent Application No. 63/633,140, filed Apr. 12, 2024, the entire contents of which are incorporated by reference herein.

### BACKGROUND

The technology of the present application relates to apparatuses and methods to produce aviation fuel and, more particularly, to apparatuses and methods to improve the distillation of sustainable aviation fuel.

Climate change is a global matter. One contributing factor to climate change is the combustion of fuels, especially petroleum-based fuels. Various industries are attempting to develop alternatives to petroleum-based fuels, such as, for example, biofuels. Additionally, industries are devising ways to offset carbon production through more efficient processes and other allowed mechanisms.

The aviation industry faces substantial challenges to reduce emissions of greenhouse gases and improve its sustainability. In particular, the number of flights, both domestic and international, has grown over the years with a corresponding increase in demand for jet fuel.

Given the desire to decrease greenhouse gases and the overall carbon footprint coupled with the increase in demand for jet fuel, it would be desirous to provide a facility capable of producing sustainable aviation fuel with a relatively lower impact on climate through, for example, lower greenhouse gas production and an overall lower carbon footprint.

Thus, against this background, it would be desirable to provide apparatuses and methods to improve distillation of sustainable aviation fuel.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some aspects of the technology, a fractional distillation system for the production of sustainable aviation fuel is provided. The fractional distillation system comprises a distillation tower having a bottom portion and a top portion. A heater is operably coupled to the bottom portion of the distillation tower to vaporize a mixture. A liquid trap in the upper section of the distillation tower has a through channel to allow vapor to flow from below the liquid trap to above the liquid trap, and the liquid trap, which may comprise a tray, traps and retains condensate of the sustainable aviation fuel. A pump pumps the sustainable aviation fuel from the liquid trap through a cooler to the top of the distillation tower. In some aspects, the top of the distillation tower includes a condensation section above the liquid trap to receive sustainable aviation fuel as a liquid and a vapor to condense the vapor to sustainable aviation fuel that is collected in the liquid trap.

In some embodiments, the pump pumps sustainable aviation fuel from the liquid trap to a nozzle that discharges the sustainable aviation fuel into the distillation tower at a point below the liquid trap.

These and other aspects of the present system and method will be apparent after consideration of the Detailed Description and Figures herein.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 is an illustrative schematic of an exemplary fractional distillation system consistent with the technology of the present application.

FIG. 2 is an illustrative schematic of an exemplary fractional distillation system consistent with the technology of the present application.

### DETAILED DESCRIPTION

The technology of the present application will now be described more fully below with reference to the accompanying figures, which form a part hereof and show, by way of illustration, specific exemplary embodiments. These embodiments are disclosed in sufficient detail to enable those skilled in the art to practice the technology of the present application. However, embodiments may be implemented in many different forms and should not be construed as being limited to the embodiments set forth herein. The following detailed description is, therefore, not to be taken in a limiting sense.

The technology of the present application is described with specific reference to apparatuses and methods to improve the distillation of sustainable aviation fuel (SAF). However, the technology described herein may be used with applications other than those specifically described herein. For example, the technology of the present application may be applicable to biodiesel production, other isobutanol or ethanol-based fuel production, or the like. Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

Aviation, especially commercial aviation, is a price-sensitive market. Jet fuel is one of the largest expenses for aviation and even minor changes in the price of crude oil can cause a significant impact on the expenses for airlines. SAF has many benefits, including a reduced impact on the climate and lower overall greenhouse gas emissions. The challenge for SAF is that the cost of SAF exceeds the cost of conventional petroleum-based jet fuel. Given the cost sensitivity of the aviation industry, there is a compelling need to produce SAF more efficiently or with other cost offsets. Efficiency should be construed broadly to include apparatuses and methods that reduce, relatively, the cost to produce SAF and/or increase, relatively, production yield. Additionally, cost offsets should be construed broadly to include offsetting carbon credits and the like.

Converting alcohol-to-jet fuel seems to be a promising method to produce SAF. The conversion of alcohol-to-jet fuel uses a fermentation process to convert sugars, starches, and/or cellulose to an intermediate alcohol. The intermediate alcohol is subsequently processed into an SAF. SAF is generally a drop-in fuel that can, currently, replace a portion of conventional petroleum jet fuel, which corresponds to up to a reduction in carbon emissions.

Converting alcohol to SAF includes a distillation process, generally known as fractional distillation. Fractional distillation is a process where component parts of a mixture are separated by vaporizing the mixture, which facilitates the separation of the mixture into its component parts. The component parts can be removed from the remainder of the mixture. The overall process of separating the mixture into the component parts is referred to as fractional distillation. The separate parts can be isolated and condensed into a homogeneous mixture subsequent to the vaporization. For clarity, in the present application, the term “homogeneous” does not necessarily mean purity but rather fluid within specification tolerances.

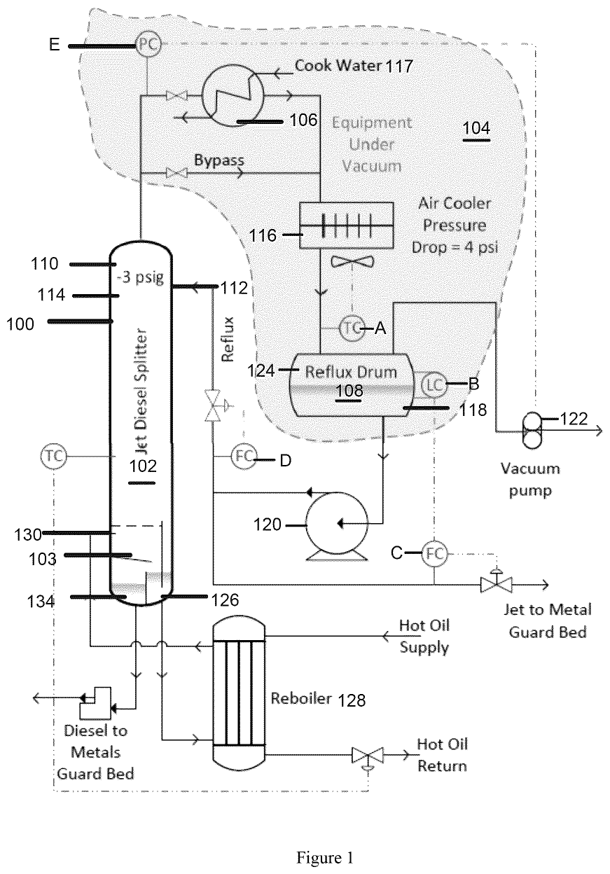

With reference now to FIG. 1, a fractional distillation system 100 and process is described. The industrial fractional distillation system 100 for SAF production uses a mixture 103, which comprises SAF and one or more heavier components in a distillation tower 102, which is shown as a generally vertical, cylindrical tower, to produce SAF, which is the lighter component, and a heavier distillate, which is the heavier component. In practice, a part of the mixture 103 at the bottom of the distillation tower 102 vaporizes, as explained below, and travels upwards along the distillation tower 102 and cools. As the vapor rises and cools, the vapor condenses and re-vaporizes. The cycle of vaporizing, condensing, and re-vaporizing increases the separation of the parts and increases the concentration of the component parts of the mixture in an upward direction. Lower boiling point component parts of the mixture travel the highest, while higher boiling point components are collected lower, and the various component parts may be removed via one or more outlets or the like.

The industrial distillation system 100, or fractional distillation system 100, described herein, includes a reflux apparatus 104 to facilitate the distillation and achieve a better separation of the component parts. The reflux apparatus 104 includes, among other things, a condenser 106 and a reflux drum 108 to condense some vapor located at the top 110 of the fractional distillation tower 102. The condensed vapor is injected through an injection port 112 back to the distillation tower 102 at a point 114 lower than the top 110. Notice, while shown as a singular port for convenience, the injection port 112, and other ports described herein, may be a single port, multiple ports, a nozzle, multiple nozzles, other manifold distributions, or the like. The condenser 106 may use cooler streams 117 from other parts of the fuel conversion system to facilitate the conservation of energy. The condensed liquid injected at the injection port 112 flows downward and acts to facilitate cooling of the vapor traveling upwards in the distillation tower 102. In certain embodiments, reflux apparatus 104 may include an air cooler 116 to further cool the condensed liquid collected in the reflux drum 108. The air cooler 116 would be controlled, for example, by a temperature controller A, such that the liquid in the reflux drum 108 achieves a desired temperature prior to injection back to the distillation tower.

The condensation 118 in reflux drum 108 is generally a homogenous, or close to homogenous, liquid that may be pumped by pump 120 to a collection reservoir not specifically shown in FIG. 1. The condensation 118 is jet fuel or SAF, sometimes referred to as liquid 118 or SAF 118. As shown in FIG. 1, the level of the condensed liquid 118 in reflux drum 108 is controlled by a level controller B, or the like, that supplies input to a flow controller C that controls the flow of the liquid to the collection reservoir. A flow controller D, also on the discharge of pump 120, is used to control the flow of condensed liquid to be injected at point 114 for the reflux cooling.

The mixture 103 in the base 126 of the distillation tower is heated by a heater 128. In this illustrative embodiment, the heater 128 may be a reboiler 128. The reboiler 128 uses an external heat source to vaporize the mixture 103, which vapor is introduced into the distillation tower 102 at an injection port 130. The vapor condenses and is separated from the mixture 103 into its component parts that have relatively lower and higher boiling points. The heavier, or higher boiling point, component part, such as, for example, a heavy distillate 134, is described above. The heavy distillate or relatively higher boiling point component part can be pumped to another reservoir.

As can be appreciated, the top 110 of the distillation tower 102 and the reflux apparatus 104 operate, in the present embodiment, at a vacuum to facilitate the fractional distillation of the mixture 103. The vacuum may be maintained by a vacuum generation system 122, such as, for example, a vacuum pump shown as operating on the head space 124 in the reflux drum 108. A pressure controller E may be used to control the pressure at the top 110 at a value. Also, as shown, the pressure in the reflux drum 108 may be different than the pressure at the top of the distillation tower due to further pressure decreases or increases over parts of the reflux apparatus 104.

As can be appreciated, the fractional distillation system 100 has several drawbacks. One exemplary drawback is that the reflux apparatus 104 operates at a vacuum. Operating at a vacuum often requires expensive parts and has a higher potential of having a leak in the vacuum portion, which may result in significant inefficiencies and potential plant downtime. Additionally, the reflux apparatus 104 requires significant high-elevation equipment, which increases the cost of the fractional distillation system 100, as the structure is required to bear a large amount of weight. Finally, the distillation tower 102 requires a larger reboiler 128 to heat the mixture 103.

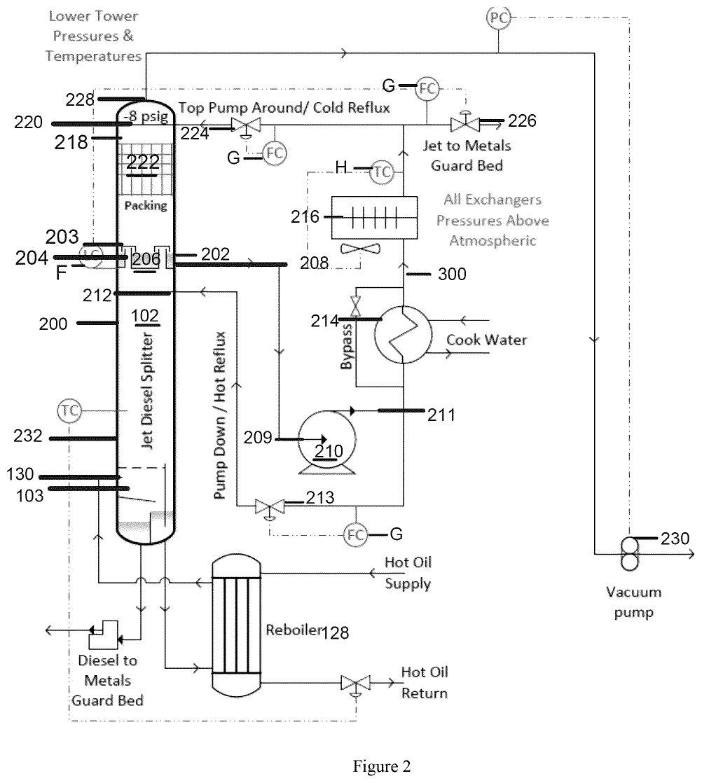

Using the mixture 103, it has been found that an alternative reflux apparatus 300 provides many benefits over the reflux apparatus 104 described above with respect to the distillation system 100. Now, with reference to FIG. 2, an improved SAF fractional distillation system 200 for the production of SAF and heavy distillate from the mixture 103 is shown and described. The SAF fractional distillation system 200 has a distillation tower 102. The mixture 103 is vaporized by a reboiler 128 and injected to the distillation tower 102 at an injection port 130. As before, vapor flows upwards in the distillation tower 102. The SAF fractional distillation system 200 provides a liquid trap 202. The liquid trap 202 has through channels 204, or chimneys 204, that allow the vapor to flow upwards past the liquid trap 202. The through channels 204 have caps 203 that allow vapor to rise above the through channel and cap but divert fluid (condensate) from channel 204 into the liquid trap 202. The liquid trap 202, which is shown as a tray or basin, holds liquid SAF 206. The level in the liquid trap 202 is controlled by a level controller F, as will be explained further below.

The liquid trap 202 has a discharge 208 that is in fluid communication with a suction 209 of a pump 210. The pump 210 draws from the liquid trap SAF 206 fluid. The discharge 211 of the pump 210 splits into a first part, comprising a hot reflux liquid, and a second part, comprising a cool reflux liquid, although the cool reflux liquid is hot when it is discharged from the pump 210. The split of the discharge is controlled by flow controllers G, which may be one or more flow controllers that operate in unison. The flow controllers G operate to control flow control valves as described herein.

The discharge 211 of the pump is in fluid communication with a hot reflux injection port 212, typically through a flow control valve 213 controlled by flow controller (or controllers) G. The hot reflux liquid exiting the injection port 212 flows downward to cool vapor on the rise and eventually re-vaporizes and rises in the distillation tower. While not shown, optionally, a cooler, such as cooler 214, may be provided between the pump discharge 211 and the injection port 212 to facilitate some cooling to the hot reflux liquid prior to it being injected back to the distillation tower 102.

The discharge 211 of the pump 210 also is in fluid communication with a cooler 214. The cooler 214, which operates as a conventional heat exchanger, cools the cool reflux liquid using a heat exchange fluid. The heat exchange fluid may be a fluid from other parts of the SAF production factory to conserve energy as the heat exchange fluid. The cool reflux liquid may be further cooled by a secondary cooler 216 until a desired temperature is reached. The temperature is controlled by a temperature controller H.

The reflux apparatus 300, as can be appreciated, is a pressurized system, unlike the vacuum system of reflux apparatus 104 described above. The reflux apparatus 300, being pressurized, provides benefits, which include cost savings and economies, such as not needing to maintain a vacuum on the reflux apparatus 300.

The cool reflux liquid is in fluid communication with a top portion 218 of the distillation tower 102 through a cool reflux injection port 220. The cool reflux liquid is injected to the top portion 218 of the distillation tower 102, which top portion 218 operates at a vacuum. The top portion 218 of the distillation tower is a condensation section 222. The condensation section 222 may include packing, filters, or the like to receive the injected cool reflux liquid. Any vapor from the distillation tower 102 that rose through the through channels 204 permeates the condensation section 222, and any associated packing, filter, etc., is cooled and condensed by the cool reflux liquid. The condensed vapor and remaining cool reflux liquid flow, downward, through the condensation section 222 and are collected in the liquid trap 202 to be supplied to pump 210.

Operation of flow control valves 224 and 226 is performed by the flow controllers G, which receive input from the level controller F. The flow control valve 226 allows the cool reflux liquid to be directed to a reservoir to collect the SAF from the distillation process. The reservoir is sometimes referred to as the lower boiling point component collection reservoir. Operation of the flow control valves 224 and 226 inhibits the liquid trap 202 from overflowing.

As indicated, the distillation tower 102 operates in a vacuum. One or more fittings 228 may be provided to couple the top portion 218 of the distillation tower 102 to a vacuum generation system 230, such as, for example, the vacuum pump as shown.

The heavy distillate collected in a bottom 232 of the distillation tower 102 may be pumped to a reservoir, not specifically shown.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims that is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10—that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A fractional distillation system for the production of sustainable aviation fuel (SAF) comprising:
a distillation tower having a bottom portion and a top portion that is configured to receive a fluid mixture comprising at least a lower boiling point component and a higher boiling point component;
a heater operably coupled to the bottom portion of the distillation tower and configured to heat the tower bottoms mixture;
a liquid trap in the distillation tower located proximal to the top portion and between the bottom portion and the top portion, the liquid trap having at least one through channel configured to allow vapor to flow from below the liquid trap to above the liquid trap, wherein the liquid trap is configured to retain condensate of the lower boiling point component of the fluid mixture;
a pump having a pump suction and a pump discharge, the suction of the pump in fluid communication with the liquid trap and configured to draw the condensate from the liquid trap and discharge the condensate at a pressure; and
a cooler in fluid communication with the pump discharge and the top portion of the distillation tower and configured such that condensate is pumped from the discharge, through the cooler, and to the top of the distillation tower.

2. The fractional distillation system of claim 1 wherein the pump discharge is in fluid communication with the cooler and a hot reflux discharge port that is configured to inject liquid condensate to the distillation tower between the bottom and the liquid trap.

3. The fractional distillation system of claim 2 comprising a cooler in fluid communication with the pump discharge and the hot reflux discharge port and configured to cool the liquid condensate.

4. The fractional distillation system of claim 1 comprising a lower boiling point component collection reservoir in fluid communication with the pump discharge.

5. The fractional distillation system of claim 1 comprising condensation section located in the distillation tower between the top portion and the liquid trap.

6. The fractional distillation system of claim 5 wherein the condensation section is configured to receive liquid condensate from a top and vapor from the bottom to condense the vapor and wherein the liquid condensate from the condensation section is contained in the liquid trap.

7. The fractional distillation system of claim 1 comprising a cap for the through channels.

8. The fractional distillation system of claim 1 comprising a secondary cooler coupled in fluid communication with the cooler and the top of the distillation tower.

9. The fractional distillation system of claim 1 comprising a cool reflux discharge port configured to inject cool reflux to the top of the distillation tower.

10. The fractional distillation system of claim 9 wherein the cool reflux discharge port comprises a plurality of nozzles.

11. The fractional distillation system of claim 1 comprising a vacuum generating system coupled to the top of the distillation tower and configured to maintain a vacuum in the distillation tower.

12. A method of fractional distillation of fluid mixtures, wherein the fluid mixture includes a lower boiling point component and a higher boiling point component, the method comprising:
receiving at a bottom of a distillation tower a fluid mixture, wherein the fluid mixture comprises at least a lower boiling point component and a higher boiling point component;
vaporizing portions of the fluid mixture into a vapor and allowing the vapor to rise into the distillation tower;
cooling the vapor as it rises in the distillation tower such that the higher boiling point component condenses prior to the lower boiling point component, and wherein a condensed higher boiling point component separates from the vapor as the vapor continues to rise;
passing the vapor, with the condensed higher boiling point component separated out, through a channel in a liquid trap, wherein the lower boiling point component condenses;
trapping a condensed lower boiling point component in the liquid trap;
removing the condensed lower boiling point component from the liquid trap; and
injecting the condensed lower boiling point component into a top of the distillation tower above the liquid trap, wherein the condensed lower boiling point component facilitates condensing any vapor in the top of the distillation tower.

13. The method of claim 12, comprising cooling the condensed lower boiling point component to a temperature prior to injecting the condensed lower boiling point component into the top.

14. The method of claim 12, wherein injecting the condensed lower boiling point component includes injecting a portion of the condensed lower boiling point component into the distillation tower below the liquid trap to facilitate condensing vapor below the liquid trap, wherein the condensed lower boiling point component injected below the liquid trap vaporizes as it condenses vapor.

15. The method of claim 13, wherein a portion of the cooled condensed lower boiling point component is collected in a reservoir.

16. The method of claim 15, wherein the portion collected in the reservoir is vehicle fuel.

17. The method of claim 16, wherein the vehicle fuel is sustainable aviation fluid (SAF).

18. The method of claim 16, comprising collecting the separated out condensed higher boiling point component in the bottom of the distillation tower and transferring the condensed higher boiling point component in the bottom to a higher boiling point component reservoir.

19. The method of claim 15, comprising controlling a level of the condensed lower boiling point component in the liquid trap by diverting the portion of the cooled condensed lower boiling point component to the reservoir when the condensed lower boiling point component in the liquid trap is at or above the level.

20. A fractional distillation system configured for distillation of alcohols into lower boiling point components and higher boiling point components comprising:
a distillation tower having a bottom portion and a top portion, the bottom portion being configured to receive a fluid mixture containing alcohol that comprises at least a lower boiling point component and a higher boiling point component, the distillation tower comprising a cool reflex injection port in the top portion and a hot reflex injection port;
a heater operably coupled to the bottom portion of the distillation tower and configured to heat the fluid mixture in the tower bottom;
a liquid trap in the distillation tower located proximal to the top portion and between the bottom portion and the top portion such that the liquid trap is above the hot reflex injection port, the liquid trap having at least one through channel configured to allow vapor to flow from below the liquid trap to above the liquid trap, wherein the liquid trap is configured to retain condensate of the lower boiling point component of the fluid mixture;
a pump having a pump suction and a pump discharge, the suction of the pump in fluid communication with the liquid trap and configured to draw the condensate from the liquid trap and discharge the condensate at a pressure; and
a cooler; wherein the discharge of the pump is in fluid communication with the cooler and the cool reflux injection port, and in fluid communication with a hot reflex injection port such that condensate is pumped from the discharge, through the hot reflex injection port and through the cooler to the cool reflux injection port.
